(19) United States
(12) Patent Application Publication
(10) Pub. No.: US 2021/0238882 A1
(43) Pub. Date: Aug. 5, 2021

(54) DOOR LOCKING SYSTEM

(71) Applicants: Michael Boyd, Heidelberg (DE); Fatos Uka, Bad Rappenau (DE)

(72) Inventors: Michael Boyd, Heidelberg (DE); Fatos Uka, Bad Rappenau (DE)

(73) Assignee: KARCHER GmbH, Bad Rappenau (DE)

(21) Appl. No.: 17/158,532

(22) Filed: Jan. 26, 2021

(30) Foreign Application Priority Data
Jan. 30, 2020 (DE) 10 2020 201 152.4

(51) Int. Cl. E05B 13/00; E05B 1/00

(52) U.S. Cl. CPC E05B 13/004; E05B 1/003

(57) ABSTRACT

A door locking system for opening and closing a door lock in a door. The door locking system includes a first door handle unit with a first door handle and a second door handle unit with a second door handle. The first door handle and the second door handle are pivotable about a common pivot axis. The door locking system comprises a coupling device with an axially aligned polygonal pin which has two pin pieces. The respective pin piece is connected to the respective door handle in a pivotably fixed manner.

### CROSS-REFERENCE TO RELATED PATENT APPLICATIONS

This patent application claims the benefit of priority to German Patent Application No. 10 2020 201 152.4, filed Jan. 30, 2020, the entire teachings and disclosures of the application are incorporated herein by reference thereto.

### FIELD

The invention relates to a door locking system for opening and closing a door lock in a door according to the preamble of claim 1.

### BACKGROUND OF THE INVENTION

A door locking system usually comprises a first door handle unit with a first door handle and a second door handle unit with a second door handle. In this case, the door handles are arranged on both sides of the door and are connected to each other in a pivotably fixed manner via a polygonal pin. As a result, the door handles can be pivoted together on the door. The polygonal pin is effectively connected here to a door lock so that when one of the door handles is pivoted, the closed door lock can be opened. In addition to the door locking system, a locking system can also be mounted on the door. In this case, the locking system can lock or unlock the door independently of the door locking system. A door with a door locking system and with an additional locking system is known, for example, from EP 2 182 144 A1. Such additional locking systems are usually installed below the door locking system and therefore require additional installation space.

### BRIEF SUMMARY OF THE INVENTION

It is therefore an object of the invention to provide an improved or at least alternative embodiment for a door locking system of the generic type with which the described disadvantages are overcome. In particular, the door locking system is to be compactly designed and to permit locking of the door lock.

This object is achieved according to the invention by the subject matter of independent claim 1. Advantageous embodiments are the subject matter of the dependent claims.

A door locking system is provided for opening and closing a door lock in a door. The door locking system comprises a first door handle unit with a first door handle and a second door handle unit with a second door handle. The first door handle and the second door handle are pivotable about a common pivot axis. The door locking system further comprises a coupling device with an axially aligned polygonal pin having a first pin piece and a second pin piece. The first pin piece is connected to the first door handle and the second pin piece is connected to the second door handle in a pivotably fixed manner. According to the invention, the pin pieces of the polygonal pin are separated from each other and only the first pin piece of the polygonal pin can be coupled to the door lock. In an installed state of the door locking system, thus with the door locking system installed in the door with a door lock, the first pin piece of the polygonal pin is coupled to the door lock for opening actuation thereof. The coupling device further comprises an axially aligned coupling pin which is arranged in the polygonal pin and is axially shiftable into a coupling position and into a decoupling position. The pin pieces of the polygonal pin are connected to each other in a pivotably fixed manner in the coupling position of the coupling pin and can be pivoted relative to each other in the decoupling position of the coupling pin.

Once the coupling pin is in the coupling position, the pin pieces and thus also the door handles are connected to each other in a pivotably fixed manner. When pivoting one of the two door handles, the two pin pieces of the polygonal pin and the other door handle are pivoted about the common pivot axis. In doing so, the door lock can be coupled to the first pin piece and can therefore be opened when one of the door handles is pivoted. If the coupling pin is in the decoupling position, the pin pieces and thus also the door handles can be pivoted relative to each other. When pivoting the second door handle, only the second pin piece is pivoted whereas the first pin piece and the first door handle do not pivot. Since the door lock can be coupled or is coupled to the first pin piece, the door lock cannot be opened when the second door handle is pivoted. However, when pivoting the first door handle, the first pin piece of the polygonal pin is always pivoted and thus the door lock that can be coupled thereto is opened.

With the door locking system according to the invention, the door lock can advantageously be opened by the two door handles in the coupling position of the coupling pin and can be opened only by the first door handle in the decoupling position of the coupling pin. This advantageous effect is achieved by the coupling pin which is arranged in the polygonal pin and thus requires no additional installation space. As a result, the door locking system according to the invention is constructed in a more compact manner compared to a conventional door locking system with an additional locking system. Expediently, the first door handle or the first door handle unit is provided for mounting on the interior side and the second door handle or the second door handle unit is provided for mounting on the exterior side.

The door closing system according to the invention can be used for implementing a privacy function. A person who wants privacy in a room—for example in a washroom or in a bathroom—can set the decoupling position. In this case, it is not possible in the decoupling position to open the door to this room with the second door handle on the outside room side. In addition, the door locking system according to the invention provides an emergency opening function since the trapped person can always open the door lock with the first door handle on the interior side. In particular, this can reduce the risk of children locking themselves in.

In an advantageous further development of the door locking system it is provided that the coupling pin projects axially outwardly from the first door handle and can be shifted manually from the outside from the coupling position into the decoupling position. As a result, the coupling pin can be shifted on the interior side into the decoupling position and the pin pieces can thus be pivotably connected to each other or decoupled from each other. Once the coupling pin is shifted into the decoupling position, the door lock can no longer be opened by the second door handle or on the exterior side. The coupling pin remains in the decoupling position until it is shifted into the coupling position.

Advantageously, the coupling device can comprise a resetting unit. When pivoting the first door handle, the resetting unit can shift the coupling pin from the decoupling position into the coupling position. Thus, once the coupling pin is in the decoupling position and the first door handle is pivoted, the coupling pin automatically transitions into the coupling position. Thereby, shifting the coupling pin from the decoupling position into the coupling position can be simplified. Furthermore, unintentional locking of the door can also be prevented, since as soon as a person pivots the first door handle on the interior side when leaving a room, the coupling pin automatically transitions into the coupling position and the door can also be opened on the exterior side. If the coupling pin is in the coupling position and the first door handle is actuated, the coupling pin remains in the coupling position. Shifting the coupling pin from the coupling position into the decoupling position can be done manually—as described above.

In a further development of the resetting unit, it can be provided that the resetting unit comprises a formation and a ramp. In this case, the formation can be formed or arranged on the coupling pin and project radially therefrom. The ramp can be formed on the first pin piece of the polygonal pin such that it is arranged transversely to the pivot axis and faces the first door handle. In the decoupling position of the coupling pin, the formation then rests against the ramp and slides axially along the ramp when the first door handle is pivoted. Since by pivoting the first door handle, the first pin piece is pivoted, the ramp also pivots about the pivot axis and axially displaces the formation from its position. As a result, the coupling pin is also axially displaced from the decoupling position into the coupling position.

Additionally, it can be provided that the resetting unit comprises a coil spring. The coil spring can be arranged around the coupling pin and is then supported axially on one side on the ramp and on the other side on a radially circumferentially extending stop edge of the coupling pin. The coil spring is axially clamped in the decoupling position of the coupling pin and supports the axial displacement of the coupling pin from the decoupling position into the coupling position when the first door handle is pivoted.

In an advantageous further development of the door locking system, it is provided that the coupling pin has a pivot area and a coupling area that is axially adjacent thereto and rotationally asymmetrical. The coupling pin and the first pin piece can then be pivotably connected to one another via the pivot area. The pivot area of the coupling pin can be cylindrical, for example. It is conceivable that for the pivot area of the coupling pin, a mating pivot contour is formed in the first pin piece. In this case, the pivot area of the coupling pin is accommodated within the mating pivot contour of the first pin piece in radially fixed, axially displaceable and pivotable manner. Moreover, a first mating contour is formed in the first pin piece, and a second mating contour is formed in the second pin piece for the coupling area. When the coupling area engages with the respective mating contour, the coupling pin and the respective pin piece can then be connected to each other in a pivotably fixed manner. In other words, the respective mating contour and the coupling area can form a pivotably fixed and positive connection with each other. The mating contours in the two pin pieces can be identical to each other.

Advantageously, in the decoupling position of the coupling pin, the coupling area can be arranged outside the first mating contour of the first pin piece and the pin pieces can therefore be pivoted relative to each other. The pivot area can be arranged in the first pin piece. In the coupling position of the coupling pin, the coupling area can then be arranged in certain section in the first mating contour of the first pin piece and in certain sections in the second mating contour of the second pin piece, and the pin pieces can therefore be connected to one another in a pivotably fixed manner In the coupling position of the coupling pin, the respective mating contours and the coupling area of the coupling pin form a pivotably fixed positive connection which allows the two pin pieces and also the door handles to pivot together about the common pivot axis. The pivot area of the coupling pin can be arranged completely in the first pin piece. By connecting the first mating contour of the first pin piece to the coupling area, the first pin piece nevertheless remains connected to the second pin piece in a pivotably fixed manner.

In an advantageous further embodiment of the door locking system, it is provided that the coupling device comprises a latching unit which axially fixes the coupling pin in the coupling position and in the decoupling position. This can prevent that the coupling pin transitions unintentionally from the decoupling position into the coupling position and vice versa.

Advantageously, the latching unit can comprise a radially resilient ball and two axially adjacent and radially aligned openings. In the coupling position, the ball is latched in the one opening and in the decoupling position it is latched in the other opening. The openings are formed in the coupling pin and the ball is fixed to the second pin piece of the polygonal pin or to the second door handle in a radially resilient manner and penetrates the second pin piece of the polygonal pin. Alternatively, it is also conceivable that the openings are formed in the coupling pin and the ball is fixed to the first pin piece of the polygonal pin or to the first door handle in radially resilient manner and penetrates the first pin piece of the polygonal pin. Alternatively, it is also conceivable that the openings are formed in the first or in the second pin piece and the ball is fixed to the coupling pin in a radially resilient manner.

In an advantageous configuration of the door locking system, it is provided that the door locking system comprises the door lock. In this case, the door lock is coupled to the first pin piece of the polygonal pin. In this case, the door lock can be opened in the decoupled position of the coupling pin exclusively by pivoting the first door handle, and can be opened in the coupled position of the coupling pin by pivoting the first door handle or by pivoting the second door handle.

Other important features and advantages of the invention are apparent from the sub-claims, from the drawings and from the associated description of figures with reference to the drawings.

It is to be understood that the aforementioned features and those to yet be explained below can be applied not only in the combination specified in each case, but also in other combinations or alone without departing from the scope of the present invention.

### BRIEF DESCRIPTION OF THE FIGURES

Preferred exemplary embodiments of the invention are illustrated in the drawings and are explained in more detail in the following description, wherein identical reference signs refer to identical or similar or functionally identical components.

In the figures, in each case schematically:

FIG. 1 shows a view of a door locking system according to the invention with a coupling pin in a coupling position;

FIG. 2 shows a view of the door locking system according to the invention with the coupling pin in a decoupling position;

FIGS. 3 and 4 show sectional views of the door locking system according to the invention with the coupling pin in the coupling position;

FIGS. 5 and 6 show sectional views of the door locking system according to the invention with the coupling pin in the decoupling position;

FIG. 7 shows an exploded view of a coupling device in the door locking system according to the invention;

FIGS. 8 to 10 show views of pin pieces of a polygonal pin of the coupling device of the door locking system according to the invention;

FIG. 11 shows a view of a portion of a coupling pin of the coupling device of the door locking system according to the invention.

### DETAILED DESCRIPTION OF THE INVENTION

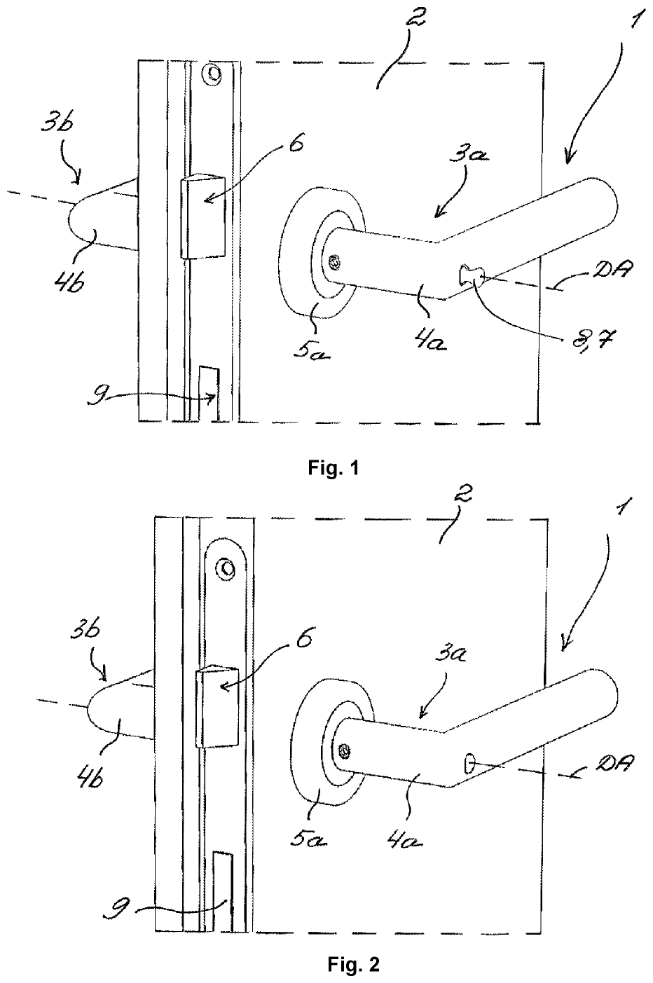

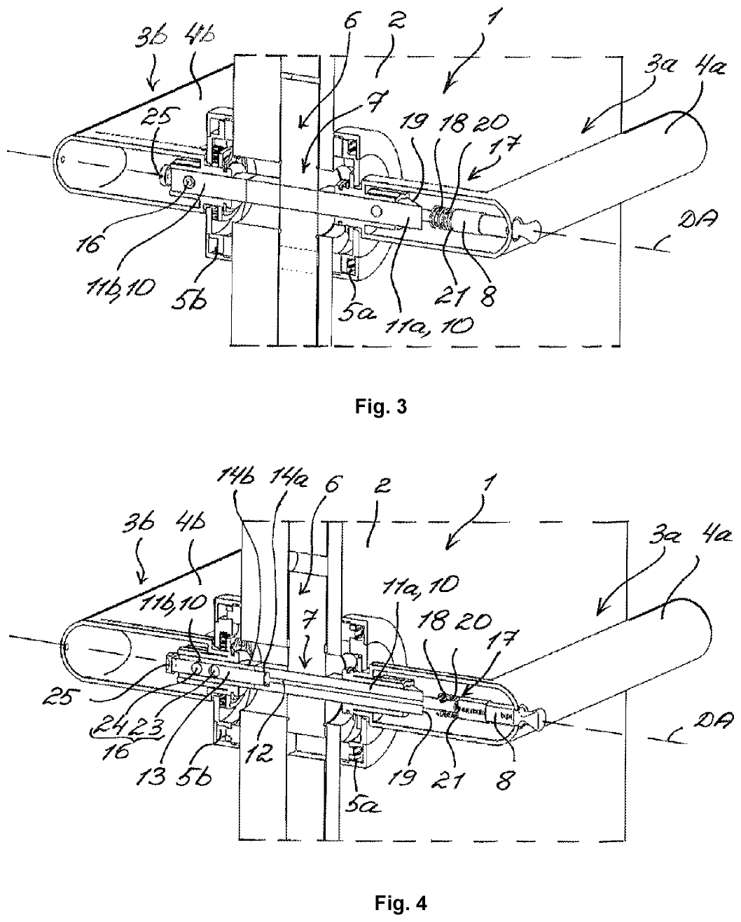

FIG. 1 and FIG. 2 show views of a door locking system 1 according to the invention. The door locking system 1 is mounted on a door 2 and comprises a first door handle unit 3a and a second door handle unit 3b. The first door handle unit 3a comprises a first door handle 4a and a first cover unit 5a which fixes the door handle 4a to the door 2 so as to be pivotable about a pivot axis DA. The second door handle unit 3b comprises a second door handle 4b and a second cover unit 5b —shown in FIGS. 3-6, —which fixes the door handle 4b to the door 2 so as to be pivotable about the pivot axis DA. The door locking system 1 further comprises a door lock 6 which can be opened by pivoting the door handles 4a and 4b about the pivot axis DA. The door handle units 3a and 3b are coupled to each other via a coupling device 7 with a coupling pin 8. In FIG. 1, the coupling pin 8 is shifted into a decoupling position and in FIG. 2 it is shifted axially relative to the pivot axis DA into a coupling position. The structure and mode of operation of the door locking system 1 according to the invention are explained in more detail below with reference to FIGS. 3-11. Below the door locking system 1, there is also arranged a lock system 9 which can be actuated independently of the door locking system 1 according to the invention and is not part of the invention.

FIG. 3 to FIG. 6 show sectional views of the door locking system 1. As can be seen here, the coupling device 7 connects the two door handles 4a and 4b axially to one another. For this purpose, the coupling device 7 has an axially aligned polygonal pin 10 which has a first pin piece 11a and a second pin piece 11b. The first pin piece 11a is axially connected to the first door handle 4a and the second pin piece 11b is axially connected to the second door handle 4b, in each case in a positive and pivotably fixed manner. Pivoting the respective door handle 4a or 4b causes the respective pin piece 11a or 11b to pivot. The two pin pieces 11a and 11b are separate from each other or are independent components and are connected to each other via the coupling pin 8. The door lock 6 is coupled to the first pin piece 11a so that the door lock 6 can only be opened when the first pin piece 11a is pivoted.

In FIG. 3 and FIG. 4, the coupling pin 8 is shifted into the coupling position. In the coupling position, the two pin pieces 11a and 11b of the polygonal pin 10 are pivotably fixed to each other and the two door handles 4a and 4b can be pivoted together about the pivot axis DA. The door lock 6 can be opened by pivoting the first door handle 4a or by pivoting the second door handle 4b. In other words, in the coupling position of the coupling pin 8, the door locking system 1 acts like a conventional door locking system with a one-piece polygonal pin.

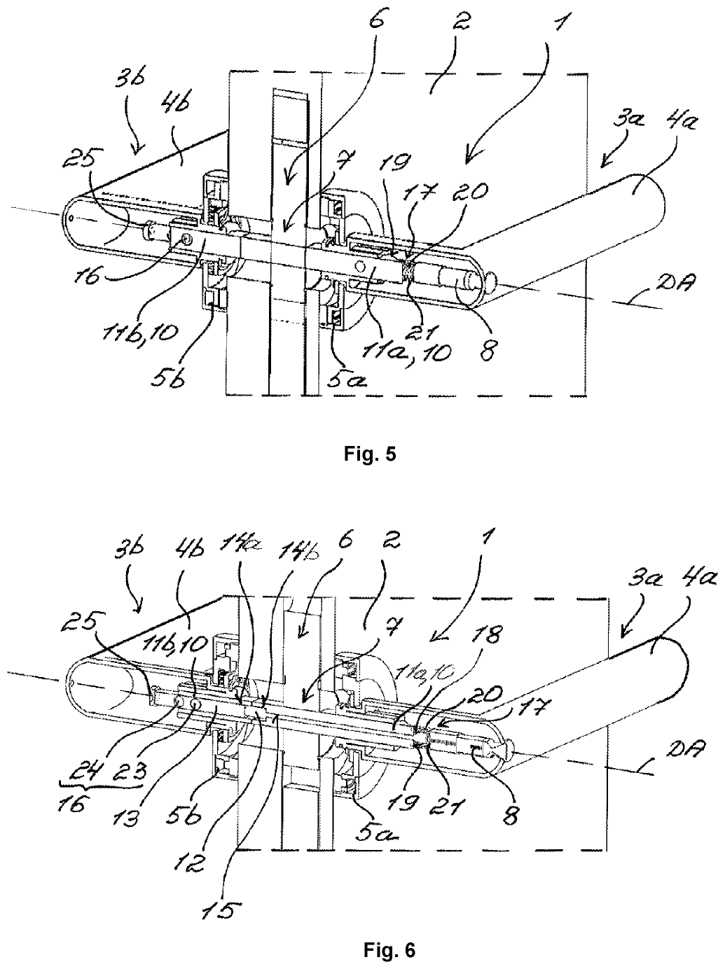

In FIG. 5 and FIG. 6, the coupling pin 8 is shifted into the decoupling position, for which purpose the coupling pin is axially displaced towards the second door handle 4b. In the decoupling position, the two pin pieces 11a and 11b of the polygonal pin 10 can be pivoted relative to each other. In the decoupling position of the coupling pin 8, the second door handle 4b and thereby the second pin piece 11b can be pivoted about the pivot axis DA, but the first pin piece 11a and the first door handle 4a are not pivoted. As a result, in the decoupling position of the coupling pin 8, the door lock 6 cannot be opened when the second door handle 4b is pivoted. However, when the first door handle 4a is pivoted, the first pin piece 11a is also pivoted, thereby opening the door lock 6.

As shown in FIG. 4 and FIG. 6, the coupling pin 8 has a pivot area 12 and a rotationally asymmetrical coupling area 13 and is arranged in the polygonal pin 10. In the first pin piece 11a, a first mating contour 14a is formed and in the second pin piece 11b, a second mating contour 14b is formed for the coupling area. The mating contours 14a and 14b are identical to each other and can receive the coupling area 13 of the coupling pin 8 in a positive manner. Moreover, in the first pin piece 11a, a mating pivot contour 15 is formed in which the pivot area 12 of the coupling pin 8 is received in a radially fixed, axially displaceable and pivotable manner.

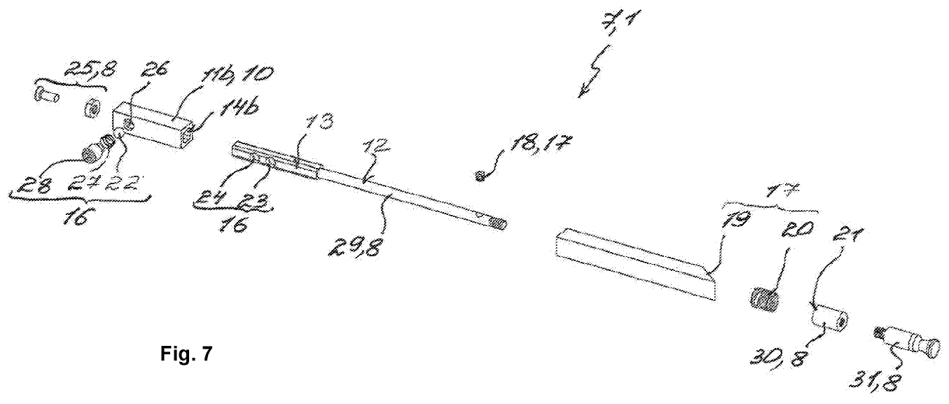

In FIG. 4, the coupling pin 8 is shown in the coupling position. Here, the coupling pin 8 is axially displaced towards the first door handle 4a so that the coupling area 13 is received in the first mating contour 14a and in the second mating contour 14b. Due to the positive fit between the coupling area 13 and the mating contours 14a and 14b, the pin pieces 11a and 11b are connected to each other in a pivotably fixed manner. In FIG. 6, the coupling pin is in the decoupling position and axially displaced toward the second door handle 4b. The coupling area 13 of the coupling pin 8 is in positive engagement only with the second mating contour 14b. The pivot area 13 of the coupling pin 8 is arranged in certain sections in the mating contour 14a and cannot prevent the coupling pin 8 from pivoting in the first pin piece 11a. The two pin pieces 11a and 11b can be pivoted relative to each other. In the coupling position and in the decoupling position, the coupling pin 8 is axially fixed to the second pin piece 11b by means of a latching unit 16. The structure and mode of operation of the latching unit 16 are explained in more detail below with reference to FIG. 7. The latching unit prevents the coupling pin 8 from unintentionally transitioning from the decoupling position into the coupling position and vice versa.

The coupling pin 8 can be manually shifted from the coupling position into the decoupling position. For this purpose, the coupling pin 8 projects axially from the first door handle 4a in the coupling position and can be shifted towards the second door handle 4b into the decoupling position. A resetting unit 17 is provided for shifting the coupling pin 8 from the decoupling position into the coupling position. The resetting unit 17 comprises a radial formation 18 on the coupling pin 8 and a ramp 19 formed transversely to the pivot axis DA on the first pin piece 11a. Once the coupling pin 8 is in the decoupling position and the first door handle 4a is pivoted, the first pin piece 11a also pivots. The ramp 19 is pivoted about the pivot axis DA and displaces the formation 18 and thereby the coupling pin 8 towards the first door handle 4a. In the process of this, a coil spring 20 of the resetting unit 17 supports the axial movement of the coupling pin 8. In the decoupling position, the coil spring 20 is clamped between the ramp 19 and a circumferentially extending stop edge 21 of the coupling pin 8 and the formation 18 rests against the ramp 19, as can be seen in FIG. 6. In the coupling position, the coil spring 20 is relaxed and the formation 18 is away from the ramp 19, as can be seen in FIG. 4.

FIG. 7 shows an exploded view of the coupling device 7. As already described above, the coupling pin 8 is held in the decoupling position and in the coupling position by means of the latching unit 16. In this case, the latching unit 16 comprises a radially resilient ball 22 and two openings 23 and 24 which are axially adjacent to one another and radially aligned. The ball 22 latches in the opening 23 in the coupling position and latches in the opening 24 in the decoupling position, as can be seen in FIG. 4 and FIG. 6. The openings 23 and 24 are formed in the coupling pin 8, and in this exemplary embodiment, the ball 22 is attached to the second pin piece 11b of the polygonal pin 10 in radially resilient manner by means of a spring 27 and a screw 28. The coupling pin 8 is multi-part and comprises an axial stop 25, a coupling pin part 29, a stop nut 30 and an actuating screw 31. The axial stop 25 is facing the second pin piece 11b and is formed by means of a screw and a nut and is fixed to the coupling pin part 29. Facing the first pin piece 11a, the stop nut 30 is screwed onto the coupling pin part 29 and forms the stop edge 21 for the coil spring 20 of the resetting unit 17. Moreover, facing away from the coupling pin part 29, the actuating screw 31 is screwed to the stop nut 21. The actuating screw 31 projects out of the first door handle 4a in certain sections.

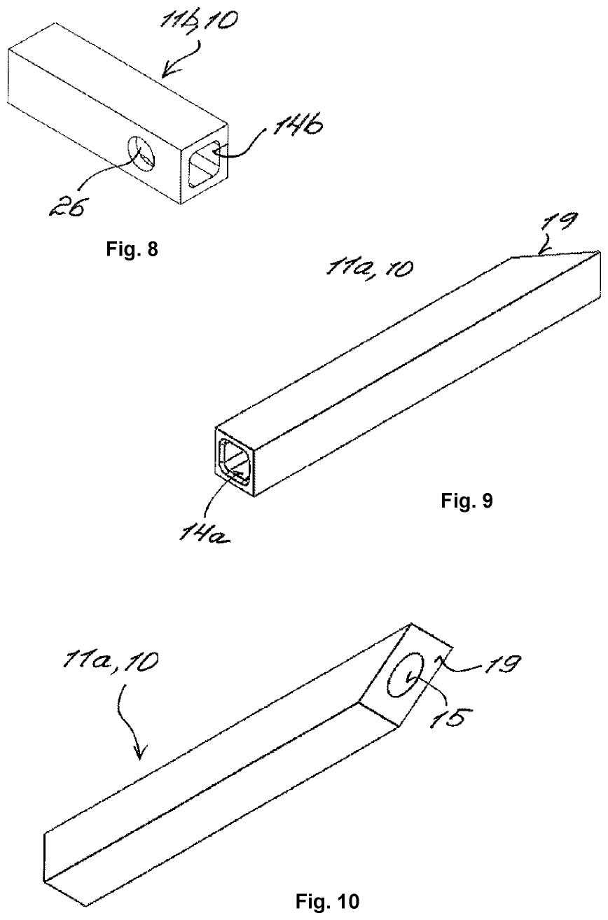

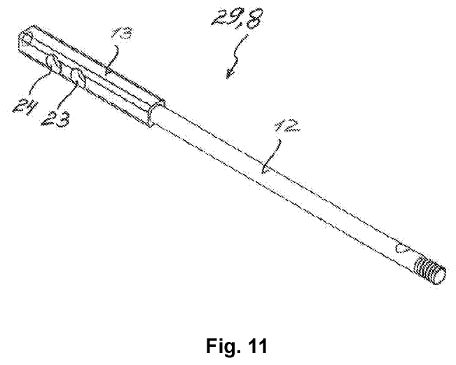

FIG. 8 shows a view of the second pin piece 11b of the polygonal pin 10. Here, a ball opening 26 can be seen, which is provided for fastening the latching unit 16 to the second pin piece 11b. FIG. 9 and FIG. 10 show views of the first pin piece 11a of the polygonal pin 10. In particular, the second mating contour 14a and the mating pivot contour 15 can be seen here. FIG. 11 shows a view of one of the coupling pin parts 29 of the coupling pin 8 of the coupling device 7.

With the door locking system 1 according to the invention, the door lock 6 can advantageously be opened in the decoupling position of the coupling pin 8 by the two door handles 4a and 4b and can be opened in the decoupling position of the coupling pin 8 exclusively by the first door handle 4a. Compared to conventional door locking systems, the door locking system 1 according to the invention is constructed in a compact and material-saving manner.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A door locking system (1) for opening and closing a door lock (6) in a door (2),
wherein the door locking system (1) comprises a first door handle unit (3a) with a first door handle (4a) and a second door handle unit (3b) with a second door handle (4b),
wherein the first door handle (4a) and the second door handle (4b) are pivotable about a common pivot axis (DA),
wherein the door locking system (1) comprises a coupling device (7) with an axially aligned polygonal pin (10) which has a first pin piece (11a) and a second pin piece (11b),
wherein the first pin piece (11a) is connected to the first door handle (4a) in a pivotably fixed manner and the second pin piece (11b) is connected to the second door handle (4b) in a pivotably fixed manner, wherein
that the pin pieces (11a, 11b) of the polygonal pin (10) are separated from one another and only the first pin piece (11a) of the polygonal pin (10) can be coupled to the door lock (6),
that the coupling device (7) comprises an axially aligned coupling pin (8) which is arranged in the polygonal pin (10) and can be shifted axially into a coupling position and into a decoupling position, and
that the pin pieces (11a, 11b) of the polygonal pin (10) are connected to one another in a pivotably fixed manner in the coupling position of the coupling pin (8) and can be pivoted relative to one another in the decoupling position of the coupling pin (8).

2. The door locking system according to claim 1, wherein
that the coupling pin (8) projects axially outwardly from the first door handle (4a) and can be shifted manually from the coupling position into the decoupling position from the outside.

3. The door locking system according to claim 1, wherein
that the coupling device (7) comprises a resetting unit (17) which, when pivoting the first door handle (4a), shifts the coupling pin (8) from the decoupling position into the coupling position.

4. The door locking system according to claim 3, wherein
that the resetting unit (17) comprises a formation (18) and a ramp (19), wherein the formation (18) is arranged on the coupling pin (8) and projects radially therefrom, and the ramp (19) is formed transversely with respect to the pivot axis (DA) on the first pin piece (11a) of the polygonal pin (10) and faces the first door handle (4a), and
that in the decoupling position of the coupling pin (8), the formation (18) rests against the ramp (19) and slides axially along the ramp (19) when the first door handle (4a) is pivoted, thereby shifting the coupling pin (8) from the decoupling position into the coupling position.

5. The door locking system according to claim 4, wherein
that the resetting unit (17) comprises a coil spring (20) which is arranged around the coupling pin (8) and is axially supported on one side on the ramp (19) and is supported on the other side on a radially circumferentially extending stop edge (21) of the coupling pin (8), and
that the coil spring (20) is axially clamped in the decoupling position of the coupling pin and supports the axial displacement of the coupling pin (8) from the decoupling position into the coupling position when the first door handle (4a) is pivoted.

6. The door locking system according to any one of claims 1, wherein
that the coupling pin (8) has a pivot area (12) and a rotationally asymmetrical coupling area (13) axially adjacent thereto, and
that the coupling pin (8) and the first pin piece (11a) can be pivotably connected to one another via the pivot area (12), and
that for the coupling area (13), a first mating contour (14a) is formed in the first pin piece (11a) and a second mating contour (14b) is formed in the second pin piece, so that when the coupling area (13) engages with the respective mating contour (14a, 14b), the coupling pin (8) and the respective pin piece (11a, 11b) can be connected to one another in a pivotably fixed manner.

7. The door locking system according to claim 6, wherein
that in the decoupling position of the coupling pin (8), the coupling area (13) is arranged outside the first mating contour (14a) of the first pin piece (11a) and as a result, the pin pieces (11a, 11b) can be pivoted relative to one another, and
that in the coupling position of the coupling pin (8), the coupling area (13) is arranged in certain sections in the first mating contour (14a) of the first pin piece (11a) and in certain sections in the second mating contour (14b) of the second pin piece (11b) and as a result, the pin pieces (11a, 11b) are connected to one another in a pivotably fixed manner.

8. The door locking system according to any one of claims 1, wherein
that the coupling device (7) has a latching unit (16) which axially fixes the coupling pin (8) in the coupling position and in the decoupling position.

9. The door locking system according to claim 8, wherein
that the latching unit (16) comprises a radially resilient ball (22) and two openings (23, 24) which are axially adjacent to one another and radially aligned, wherein the ball (22) is latched into one opening (23) in the coupling position and into the other opening (24) in the decoupling position, and
that the openings (23, 24) are formed in the coupling pin (8) and the ball (22) is fixed to the second pin piece (11b) of the polygonal pin (10) or to the second door handle (4b) in a radially resilient manner and penetrates the second pin piece (11b) of the polygonal pin (10).

10. The door locking system according to any one of claims 1, wherein
that the door locking system (1) comprises the door lock (6) which is coupled to the first pin piece (11a) of the polygonal pin (10), and
that the door lock (6) can be opened in the decoupling position of the coupling pin (8) exclusively by pivoting the first door handle (4a) and can be opened in the coupling position of the coupling pin (8) by pivoting the first door handle (4a) or by pivoting the second door handle (4b).
